(19) United States
(12) Patent Application Publication
(10) Pub. No.: US 2024/0199858 A1
(43) Pub. Date: Jun. 20, 2024

(54) RUBBER COMPOSITION FOR BASE TREAD AND PNEUMATIC TIRE USING THE SAME

(71) Applicant: Toyo Tire Corporation, Itami-shi (JP)

(72) Inventor: Satoshi Fukunishi, Itami-shi (JP)

(73) Assignee: Toyo Tire Corporation, Itami-shi (JP)

(21) Appl. No.: 18/387,526

(22) Filed: Nov. 7, 2023

(30) Foreign Application Priority Data
Dec. 8, 2022 (JP) 2022-196407

(51) Int. Cl. C08L 7/00; B60C 1/00; B60C 11/00

(52) U.S. Cl. CPC C08L 7/00; B60C 1/0016; B60C 11/0008; B60C 11/005; C08L 2205/02; C08L 2205/03

(57) ABSTRACT

A rubber composition for base tread containing 100 parts by mass of a rubber component, 5 to 50 parts by mass of silica, and 20 to 65 parts by mass of carbon black, in which the rubber component contains 50 to 85 parts by mass of a natural rubber and 15 to 45 parts by mass of a hydrogenated copolymer obtained by hydrogenating an aromatic vinyl/conjugated diene copolymer, the hydrogenated copolymer having a weight-average molecular weight measured by a gel permeation chromatography of 300,000 or more, and a degree of hydrogenation of conjugated diene units of 80 mol % or more.

### BACKGROUND OF THE INVENTION

### 1. Field of the Invention

The present invention relates to a rubber composition for base tread and a pneumatic tire using the same.

### 2. Description of Related Art

In recent years, the demand for better fuel economy of tires has been increasing, and it has been increasingly difficult to meet the demand only through better fuel economy of a cap tread constituting a grounding surface. Therefore, better fuel economy by the improvement of heat build-up property and handling stability (hardness) of a base tread is also becoming important.

Additionally, in the base tread, when a crack is generated in a groove bottom, it is important that the crack does not grow, and thus cut resistance (breaking strength and tear strength) is strongly required.

JP6627511B describes a pneumatic tire having improved rubber fracture strength, fuel economy, and handling stability, the tire being formed from a rubber composition containing a hydrogenated styrene-butadiene copolymer, carbon black having a predetermined specific surface area, and silica. However, there has been room for improvement in tear strength.

### SUMMARY OF THE INVENTION

In view of the above points, an object of the invention is to provide a rubber composition for base tread and a pneumatic tire using the same, the composition being able to obtain excellent hardness, breaking strength, and tear strength while maintaining heat build-up property.

JPH11-349732A, JP4402566B, and JP5992160B describe rubber compositions that can improve rolling resistance property, handling stability, and/or cut resistance. However, none of those rubber compositions contain hydrogenated copolymer.

The invention includes the following embodiments.
[1] A rubber composition for base tread containing 100 parts by mass of a rubber component, 5 to 50 parts by mass of silica, and 20 to 65 parts by mass of carbon black in which the rubber component contains 50 to 85 parts by mass of a natural rubber and 15 to 45 parts by mass of a hydrogenated copolymer obtained by hydrogenating an aromatic vinyl/conjugated diene copolymer, the hydrogenated copolymer having a weight-average molecular weight measured by a gel permeation chromatography of 300,000 or more, and a degree of hydrogenation of conjugated diene units of 80 mol % or more.
[2] The rubber composition for base tread according to [1], in which the hydrogenated copolymer has a functional group at an end thereof.
[3] A pneumatic tire formed by using the rubber composition according to [1] or [2] for a base tread.

According to the rubber composition for base tread of the invention, a pneumatic tire having excellent hardness, breaking strength, and tear strength while maintaining heat build-up property can be obtained.

### DESCRIPTION OF EMBODIMENTS

Matters related to the implementation of the invention are described in detail below.

The rubber composition for base tread according to the present embodiment contains 100 parts by mass of a rubber component, 5 to 50 parts by mass of silica, and 20 to 65 parts by mass of carbon black, in which the rubber component contains 50 to 85 parts by mass of a natural rubber and 15 to 45 parts by mass of a hydrogenated copolymer obtained by hydrogenating an aromatic vinyl/conjugated diene copolymer, the hydrogenated copolymer having a weight-average molecular weight measured by a gel permeation chromatography of 300,000 or more, and a degree of hydrogenation of conjugated diene units of 80 mol % or more.

The rubber component used in the rubber composition according to the embodiment contains a hydrogenated copolymer obtained by hydrogenating an aromatic vinyl/conjugated diene copolymer, the hydrogenated copolymer having a weight-average molecular weight measured by a gel permeation chromatography of 300,000 or more, and a degree of hydrogenation of conjugated diene units of 80 mol % or more. In the present specification, the weight-average molecular weight measured by a gel permeation chromatography (GPC) means a value calculated in polystyrene conversion using a commercially available standard polystyrene, using a differential refractive index detector (RI) as a detector, using THF as a solvent, and setting measurement temperature at 40° C., flow rate at 1.0 mL/min, concentration at 1.0 g/L, and injection volume to 40 μL. The degree of hydrogenation means a value calculated from the rate of decrease in the intensity of an H¹-NMR spectrum corresponding to unsaturated bonds.

Non-limiting examples of an aromatic vinyl constituting the aromatic vinyl/conjugated diene copolymer include styrene, α-methylstyrene, 1-vinylnaphthalene, 3-vinyltoluene, ethylvinylbenzene, divinylbenzene, 4-cyclohexylstyrene, and 2,4,6-trimethylstyrene. Each of these may be used alone, or two or more of these may be used in combination.

Non-limiting examples of a conjugated diene constituting the aromatic vinyl/conjugated diene copolymer include 1,3-butadiene, isoprene, 1,3-pentadiene, 2,3-dimethylbutadiene, 2-phenyl-1,3-butadiene, and 1,3-hexadiene. Each of these may be used alone, or two or more of these may be used in combination.

The aromatic vinyl/conjugated diene copolymer is not particularly limited, and is preferably a copolymer of styrene and 1,3-butadiene (styrene-butadiene copolymer). Therefore, the hydrogenated copolymer is preferably a hydrogenated styrene-butadiene copolymer. The hydrogenated copolymer may be a random copolymer, a block copolymer, or an alternating copolymer.

The hydrogenated copolymer may be synthesized, for example, by synthesizing an aromatic vinyl/conjugated diene copolymer, followed by performing hydrogenation. Non-limiting examples of the method for synthesizing the aromatic vinyl/conjugated diene copolymer include solution polymerization, vapor phase polymerization, and bulk polymerization, and solution polymerization is particularly preferable. The polymerization may be carried out in a batch mode or in a continuous mode. As the aromatic vinyl/conjugated diene copolymer, a commercially available product may be used.

The method of hydrogenation is not particularly limited, and the hydrogenation may be performed by a known method under known conditions. Usually, the hydrogenation is performed at 20 to 150° C. under 0.1 to 10 MPa hydrogen pressure in the presence of a hydrogenation catalyst. The degree of hydrogenation may be set appropriately by changing, for example, the amount of hydrogenation catalyst, the hydrogen pressure during the hydrogenation reaction, or the duration of the reaction. The hydrogenation catalyst used may be usually a compound containing any of the metals of groups 4 to 11 of the periodic table. For example, compounds containing any of Ti, V, Co, Ni, Zr, Ru, Rh, Pd, Hf, Re, and Pt atoms can be used as the hydrogenation catalyst. More specific examples of the hydrogenation catalyst include metallocene compounds including metals such as Ti, Zr, Hf, Co, Ni, Pd, Pt, Ru, Rh, and Re; supported heterogeneous catalysts in which a metal such as Pd, Ni, Pt, Rh, or Ru is supported on a carrier such as carbon, silica, alumina, or diatomaceous earth; homogeneous Ziegler catalysts in which an organic salt or acetylacetone salt of a metal element such as Ni or Co is combined with a reducing agent such as an organoaluminum; organometallic compounds or complexes of Ru, Rh, or other metals; and fullerenes and carbon nanotubes in which hydrogen is stored.

The degree of hydrogenation of the hydrogenated copolymer (the hydrogenated proportion of the conjugated diene units of the aromatic vinyl/conjugated diene copolymer) is 80 mol % or more and preferably 90 mol % or more.

The weight-average molecular weight of the hydrogenated copolymer is not particularly limited as long as it is 300,000 or more, and is preferably 300,000 to 2,000,000, more preferably 300,000 to 1,000,000, and further preferably 300,000 to 600,000.

The hydrogenated copolymer may have a functional group at an end thereof. Examples of the functional group include an amino group, a group having a carbon-nitrogen double bond, a nitrogen-containing heterocyclic group, a phosphino group, a thiol group, a hydrocarbyloxysilyl group, and a group represented by the formula (1) below. These functional groups may be introduced to only one end of the polymer, or may be introduced to both ends of the polymer. By having the functional group, an interaction with reinforcing fillers is ready to be obtained.

Examples of the group having a carbon-nitrogen double bond include “—N═CR¹R²”. Here, R¹ is a hydrogen atom or a hydrocarbyl group, and R² is a hydrocarbyl group. The hydrocarbyl group is preferably a linear or branched alkyl group having 1 to 20 carbon atoms, a cycloalkyl group having 3 to 20 carbon atoms, or an aryl group having 6 to 20 carbon atoms.

The nitrogen-containing heterocyclic group is a group obtained by removing one hydrogen atom included in a nitrogen-containing heterocyclic ring, and examples of the nitrogen-containing heterocyclic group include 1-imidazolyl group, 4,5-dihydro-1-imidazolyl group, 1-piperidino group, 1-piperazinyl group, pyridyl group, and morpholino group.

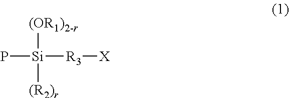

In the formula (1), R₁ is a hydrogen atom or a hydrocarbyl group and is preferably a hydrogen atom or a hydrocarbyl group having 1 to 20 carbon atoms. R₂ is a hydrocarbyl group and is preferably a hydrocarbyl group having 1 to 20 carbon atoms. r represents the number of R₂'s and is an integer of 0 to 2. R₃ is a hydrocarbylene group and is preferably a hydrocarbylene group having 1 to 20 carbon atoms. X is a functional group having one or more atoms selected from the group consisting of nitrogen, phosphorus, and sulfur, in which an atom bonded to R₃ is nitrogen, phosphorus, or sulfur. Examples of such the functional group include an amino group, a bis(trimethylsilyl)amino group, a thiol group, a phosphino group, a group having a carbon-nitrogen double bond, a nitrogen-containing heterocyclic group, and a hydrocarbyloxysilyl group, in which the amino group, the phosphino group, and the thiol group include ones protected by trisubstituted hydrocarbylsilyl group or the like. When X is an amino group, it may be a primary amino group, a nitrogen-containing group obtained by substituting two hydrogen atoms of a primary amino group with two protecting groups (for example, hydrocarbylsilyl groups), a secondary amino group, a nitrogen-containing group obtained by substituting one hydrogen atom of a secondary amino group with one protecting group (for example, a hydrocarbylsilyl group), a tertiary amino group, etc. In the formula (1), each of the plural R₁'s and R₂'s may be the same or different from each other. “P” in the formula (1) indicates a bond bonded to the polymer chain.

The content of the hydrogenated copolymer per 100 parts by mass of the rubber component is 15 to 45 parts by mass and preferably 20 to 40 parts by mass. When the content of the hydrogenated copolymer falls within the above-described ranges, an excellent hardness is ready to be obtained while maintaining heat build-up property.

The content of the natural rubber per 100 parts by mass of the rubber component is 50 to 85 parts by mass and preferably 60 to 80 parts by mass. When the content of the natural rubber falls within the above-described ranges, excellent breaking strength and tear strength are ready to be obtained. The mechanism thereof is uncertain, but is assumed that the natural rubber excellent in tear strength is formed as a continuous phase.

The rubber component may contain diene rubbers other than the hydrogenated copolymer and the natural rubber. Examples of the other diene rubbers include an isoprene rubber (IR), a butadiene rubber (BR), a styrene-butadiene rubber (SBR), a styrene-isoprene copolymer rubber, a butadiene-isoprene copolymer rubber, and a styrene-isoprene-butadiene copolymer rubber. Among these, butadiene rubber is preferred. Each of these other diene rubbers may be used alone, or two or more thereof may be blended and used. When butadiene rubber is contained, the content of the butadiene rubber is preferably 5 to 35 parts by mass, the content of the hydrogenated copolymer is preferably 15 to 45 parts by mass, and the content of the natural rubber is preferably 50 to 75 parts by mass.

The rubber composition according to the embodiment contains carbon black and silica as reinforcing fillers. By using carbon black and silica in combination, dispersibility of the fillers is improved, a filler network which stops crack growth is formed uniformly, and thereby excellent breaking strength and tear strength are ready to be obtained.

The carbon black is not particularly limited and various known varieties can be used. The content of the carbon black per 100 parts by mass of the rubber component is 20 to 65 parts by mass and preferably 20 to 50 parts by mass.

The silica is not particularly limited and a wet silica such as a wet-precipitation silica or a wet-gel silica is preferably used. The content of the silica per 100 parts by mass of the rubber component is 5 to 50 parts by mass and preferably 10 to 40 parts by mass.

The content of the reinforcing fillers is not particularly limited and is, per 100 parts by mass of the rubber component, preferably 25 to 120 parts by mass, more preferably 40 to 100 parts by mass, and further preferably 40 to 80 parts by mass.

The rubber composition according to the embodiment may further contain a silane coupling agent such as sulfidosilane or mercaptosilane. When the silane coupling agent is contained, the content thereof is preferably 2 to 20% by mass relative to the content of the silica.

In the rubber composition according to the embodiment, compounding chemicals used in the normal rubber industry, in addition to the above-described components, may be appropriately blended in a normal range. Examples of the compounding chemicals include process oil, zinc oxide, stearic acid, a softening agent, a plasticizer, a wax, a vulcanizing agent, and a vulcanization accelerator.

Examples of the vulcanizing agent include a sulfur component such as powdery sulfur, precipitated sulfur, colloidal sulfur, insoluble sulfur, and highly dispersible sulfur. The content of the vulcanizing agent is not particularly limited and is, per 100 parts by mass of the rubber component, preferably 0.1 to 10 parts by mass and more preferably 0.5 to 5 parts by mass. The content of the vulcanization accelerator is, per 100 parts by mass of the rubber component, preferably 0.1 to 7 parts by mass and more preferably 0.5 to 5 parts by mass.

The rubber composition according to the embodiment can be prepared by kneading in accordance with a usual method using a mixer normally used, such as a Banbury mixer, a kneader, or a roll. Specifically, in the first mixing stage, additives other than the vulcanizing agent and the vulcanization accelerator are added to the rubber component, followed by mixing, and then in the last mixing stage, the vulcanizing agent and the vulcanization accelerator are added to the mixture obtained, followed by mixing, to prepare the rubber composition.

The rubber composition obtained in the above-described manner is preferably used as a rubber composition for base tread in a tread composed of two layers including a cap tread on a grounding surface side and a base tread on an inner side in the tire radial direction. An unvulcanized base tread rubber member can be obtained, for example, by extruding and molding the above-described rubber composition into a predetermined cross-sectional shape corresponding to the base tread, or by spirally winding a ribbon-shaped rubber strip formed of the above-described rubber composition on a drum to form into a cross-sectional shape corresponding to the base tread. The base tread rubber member is, together with other tire members composing a tire, such as an inner liner, a carcass, a belt, a bead core, a bead filler, and a sidewall, set up into a tire shape in accordance with a usual method to give a green tire (unvulcanized tire). Then, by vulcanizing and molding the obtained green tire at for example 140 to 180° C. in accordance with a usual method, a pneumatic tire with the base tread formed of the base tread rubber member can be obtained.

The kind of the pneumatic tire according to the embodiment is not particularly limited, and examples thereof include various tires such as a tire for passenger cars, and a heavy-duty tire used for trucks, buses, etc.

### EXAMPLES

Examples of the invention are described below, but the invention is not limited to these Examples.

### <Synthesis Example of Hydrogenated Copolymer>

To a nitrogen-purged heat-resistant reaction vessel were charged 2.5 L of cyclohexane, 50 g of tetrahydrofuran, 0.12 g of n-butyllithium, 100 g of styrene, and 400 g of 1,3-butadiene, followed by polymerizing at the reaction temperature of 50° C. After the completion of the polymerization, 1.7 g of N,N-bis(trimethylsilyl)aminopropyl methyl diethoxysilane was added to the reaction solution, followed by performing reaction for one hour. Hydrogen gas was then supplied to the reaction solution at a pressure of 0.4 MPa-gauge, followed by stirring for 20 minutes to perform reaction. Next, the solution temperature was set at 90° C. hydrogen gas was supplied to the reaction vessel, and titanocene dichloride, diethylaluminum chloride, and n-butyl lithium were added thereto. Hydrogen pressure inside the vessel was kept at 0.7 MPa, and reaction was continued until the degree of hydrogenation reached a desired value. After the reaction, the pressure was returned to the normal pressure and polymer solution was obtained. By adding methanol to the obtained solution, precipitation and solvent removal drying were performed to obtain hydrogenated copolymer having a structure represented by the following formula (2) at the end. “P” in the formula (2) indicates a bond bonded to the polymer chain.

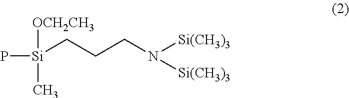

The weight-average molecular weight of the hydrogenated copolymer obtained was measured using “LC-10A” manufactured by Shimadzu Corporation as a measuring apparatus, using “PLgel-MIXED-C” manufactured by Polymer Laboratories as a column and a differential refractive index detector (RI) as a detector, using THF as a solvent, and setting measurement temperature at 40° C., flow rate at 1.0 mL/min. concentration at 1.0 g/L, and injection volume to 40 μL. As a result, the weight-average molecular weight was 350,000 in polystyrene conversion with standard polystyrene. A bound styrene content was 20% by mass and the degree of hydrogenation of butadiene units was 90 mol %. The bound styrene content was obtained from a spectrum intensity ratio between proton based on styrene units and proton based on butadiene units (including hydrogenated units) using H¹-NMR.

### Examples and Comparative Examples

Using a Banbury mixer and in accordance with the formulation (parts by mass) shown in Table 1 below, in the first mixing stage (nonproductive mixing step), components other than vulcanization accelerator and sulfur were mixed (temperature at discharge was 160° C.), and then in the last mixing stage (productive mixing step), vulcanization accelerator and sulfur were added to the mixture obtained, followed by mixing (temperature at discharge was 90° C.), to prepare the rubber composition.

Details of the components in Table 1 are as follows.
NR: RSS #3
BR1: “Buna CB22” manufactured by Lanxess
BR2: “UBEPOL-VCR617” manufactured by Ube Industries, Ltd.; vinyl cis-butadiene rubber
BR3: “BR1250” manufactured by Zeon Corporation: tin-modified polybutadiene rubber
Hydrogenated copolymer: hydrogenated copolymer prepared according to the above-described synthesis example; weight-average molecular weight was 350,000; degree of hydrogenation was 90 mol %
SBR: “SBR1502” manufactured by ENEOS Corporation
Carbon black: “Seast SO” manufactured by Tokai Carbon Co., Ltd.; nitrogen adsorption specific surface area was 42 m²/g
Silica: “Ultrasil VN3” manufactured by Evonik Industries
Silane coupling agent: “Si69” manufactured by Evonik Industries; bis(3-triethoxysilylpropyl)tetrasulfide
Zinc oxide: “Zinc oxide #2” manufactured by Mitsui Mining & Smelting Co., Ltd.
Stearic acid: “Lunac S-20” manufactured by Kao Corporation
Wax: “OZOACE0355” manufactured by Nippon Seiro Co., Ltd.
Antioxidant: “Antigen 6C” manufactured by Sumitomo Chemical Company, Limited
Vulcanization accelerator 1: “Soxinol CZ” manufactured by Sumitomo Chemical Company, Limited
Vulcanization accelerator 2: “Nocceler D” manufactured by Ouchi Shinko Chemical Industrial Co., Ltd.
Sulfur: “Powdery sulfur” manufactured by Tsurumi Chemical Industry Co., Ltd.

Hardness, heat build-up property, breaking strength, and tear strength of each of the rubber compositions obtained were evaluated. Evaluation methods were as below.
Hardness: A test piece having a thickness of 20 mm was prepared and vulcanized at 160° C. for 30 minutes to obtain a sample. Hardness at 23° C. was measured in conformity to JIS K6253 using a type A durometer, and was indicated as an index with the value in Comparative Example 1 being regarded as 100. A larger index indicates that handling stability is more excellent.
Heat build-up property: With respect to the test piece having been vulcanized at 160° C. for 30 minutes, a loss coefficient tan b was measured under conditions of a frequency of 10 Hz, a static strain of 10%, a dynamic strain of 1%, and a temperature of 60° C., using a viscoelasticity tester manufactured by Toyo Seiki Co., Ltd., and was indicated as an index with the value in Comparative Example 1 being regarded as 100. A smaller index indicates that heat build-up property is more excellent. In the case that the index was 105 or less, the rubber composition was evaluated to be able to keep the heat build-up property.
Breaking strength: A dumbbell-shaped No. 3 type test piece was prepared and vulcanized at 160° C. for 30 minutes to obtain a sample. By a tensile test in conformity to JIS K6251, tensile strength at break was measured and was indicated as an index with the value in Comparative Example 1 being regarded as 100. A larger index indicates that tensile strength is larger and reinforcing performance is more excellent.
Tear strength: A crescent-shaped test piece was prepared and vulcanized at 160° C. for 30 minutes to obtain a sample. In conformity to JIS K6252, tear strength was measured and was indicated as an index with the value in Comparative Example 1 being regarded as 100. A larger index indicates that tear strength is larger.

TABLE 1

| | Comp. | Comp. | Comp. | Comp. | | | | | | | Comp. | Comp. | Comp. |
|---|---|---|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 | Ex. 5 | Ex. 6 | Ex. 7 |
| NR | 70 | 70 | 70 | 70 | 70 | 60 | 60 | 80 | 70 | 70 | 70 | 40 | 40 |
| BR1 | 30 | 30 | — | — | — | 10 | — | — | — | — | — | 30 | — |
| BR2 | — | — | 30 | 20 | — | — | — | — | — | — | — | — | — |
| BR3 | — | — | — | 10 | — | — | — | — | — | — | — | — | — |
| Hydrogenated | — | — | — | — | 30 | 30 | 40 | 20 | 30 | 30 | — | 30 | 60 |
| copolymer | | | | | | | | | | | | | |
| SBR | — | — | — | — | — | — | — | — | — | — | 30 | — | — |
| Carbon black | 50 | 50 | 50 | 50 | 50 | 50 | 50 | 50 | 40 | 20 | 50 | 50 | 50 |
| Silica | — | 10 | — | — | 10 | 10 | 10 | 10 | 20 | 40 | 10 | 10 | 10 |
| Silane coupling | — | 0.8 | — | — | 0.8 | 0.8 | 0.8 | 0.8 | 0.8 | 0.8 | 0.8 | 0.8 | 0.8 |
| agent | | | | | | | | | | | | | |
| Zinc oxide | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 | 2 |
| Antioxidant | 1 | 1 | 1 | 1 | 1 | 1 | 1 | 1 | 1 | 1 | 1 | 1 | 1 |
| Vulcanization | 1.4 | 1.4 | 1.4 | 1.4 | 1.4 | 1.4 | 1.4 | 1.4 | 1.4 | 1.4 | 1.4 | 1.4 | 1.4 |
| accelerator 1 | | | | | | | | | | | | | |
| Vulcanization | — | 1 | — | — | 1 | 1 | 1 | 1 | 1 | 1 | 1 | 1 | 1 |
| accelerator 2 | | | | | | | | | | | | | |
| Sulfur | 2.3 | 2.3 | 2.3 | 2.3 | 2.3 | 2.3 | 2.3 | 2.3 | 2.3 | 2.3 | 2.3 | 2.3 | 2.3 |
| Hardness | 100 | 102 | 106 | 98 | 108 | 108 | 113 | 112 | 107 | 105 | 102 | 102 | 106 |
| Heat build-up | 100 | 108 | 107 | 100 | 105 | 102 | 100 | 102 | 103 | 102 | 118 | 103 | 105 |
| property | | | | | | | | | | | | | |
| Breaking strength | 100 | 106 | 92 | 102 | 116 | 115 | 117 | 118 | 112 | 109 | 100 | 101 | 117 |
| Tear strength | 100 | 143 | 117 | 110 | 132 | 126 | 106 | $17 | 137 | 139 | 72 | 88 | 84 |

The results were as shown in Table 1. In Examples 1 to 6, compared to Comparative Example 1, excellent hardness, breaking strength, and tear strength were able to be obtained while maintaining heat build-up property.

Comparative Example 2 was an example in which silica was blended to Comparative Example 1 and the content of reinforcing fillers was increased. In Comparative Example 2, compared to Comparative Example 1, heat build-up property was poor.

Comparative Example 3 was an example in which butadiene rubber in Comparative Example 1 was changed to vinyl cis-butadiene rubber. In Comparative Example 3, compared to Comparative Example 1, heat build-up property and breaking strength were poor.

Comparative Example 4 was an example in which apart of vinyl cis-butadiene rubber in Comparative Example 3 was changed to modified butadiene rubber. In Comparative Example 4, compared to Comparative Example 1, hardness was poor.

Comparative Example 5 was an example in which butadiene rubber in Comparative Example 2 was changed to styrene-butadiene rubber (not hydrogenated). In Comparative Example 5, compared to Comparative Example 1, heat build-up property and tear strength were poor.

Comparative Example 6 was an example in which the formulation of the rubber component was changed from that in Example 1 and the content of natural rubber was outside the predetermined range. In Comparative Example 6, compared to Comparative Example 1, tear strength was poor.

Comparative Example 7 was an example in which the formulation of the rubber component was changed from that in Example 1 and the content of hydrogenated copolymer was outside the predetermined range. In Comparative Example 7, compared to Comparative Example 1, tear strength was poor.

The rubber composition for base tread of the invention can be used for various tires of passenger cars, light trucks, buses, etc.

What is claimed is:

1. A rubber composition for base tread comprising:
100 parts by mass of a rubber component;
5 to 50 parts by mass of silica; and
20 to 65 parts by mass of carbon black, wherein
the rubber component contains 50 to 85 parts by mass of a natural rubber and 15 to 45 parts by mass of a hydrogenated copolymer obtained by hydrogenating an aromatic vinyl/conjugated diene copolymer, the hydrogenated copolymer having a weight-average molecular weight measured by a gel permeation chromatography of 300,000 or more, and a degree of hydrogenation of conjugated diene units of 80 mol % or more.

2. The rubber composition for base tread according to claim 1, wherein the hydrogenated copolymer is a hydrogenated styrene-butadiene copolymer.

3. The rubber composition for base tread according to claim 1, wherein the hydrogenated copolymer has a functional group at an end thereof.

4. The rubber composition for base tread according to claim 3, wherein the functional group is at least one selected from the group consisting of an amino group, a group having a carbon-nitrogen double bond, a nitrogen-containing heterocyclic group, a phosphino group, a thiol group, a hydrocarbyloxysilyl group, and a group represented by the following formula (1): 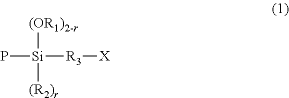
wherein R₁ represents a hydrogen atom or a hydrocarbyl group, R₂ represents a hydrocarbyl group, r represents an integer of 0 to 2, R₃ represents a hydrocarbylene group, X represents a functional group having one or more atoms selected from the group consisting of nitrogen, phosphors, and sulfur, wherein an atom bonded to R₃ is nitrogen, phosphorus, or sulfur, and P represents a bond bonded to the polymer chain.

5. The rubber composition for base tread according to claim 3, wherein the functional group is a group represented by the following formula (1): 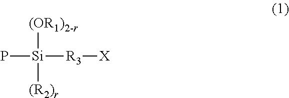
wherein R₁ represents a hydrocarbyl group having 1 to 20 carbon atoms, R₂ represents a hydrocarbyl group having 1 to 20 carbon atoms, r represents an integer of 0 to 2, R₃ represents a hydrocarbylene group having 1 to 20 carbon atoms, X represents an amino group that may have a protecting group, a thiol group that may have a protecting group, a phosphino group that may have a protecting group, a group having a carbon-nitrogen double bond, a nitrogen-containing heterocyclic group, or a hydrocarbyloxysilyl group, and P represents a bond bonded to the polymer chain.

6. The rubber composition for base tread according to claim 5, wherein X in the formula (1) represents a primary amino group, a nitrogen-containing group obtained by substituting two hydrogen atoms of a primary amino group with two protecting groups, a secondary amino group, a nitrogen-containing group obtained by substituting one hydrogen atom of a secondary amino group with one protecting group, or a tertiary amino group.

7. The rubber composition for base tread according to claim 3, wherein the functional group is a group represented by the following formula (2): 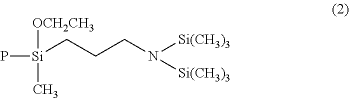
wherein P represents a bond bonded to the polymer chain.

8. The rubber composition for base tread according to claim 1, wherein the rubber component further contains a butadiene rubber and, per 100 parts by mass of the rubber component, the hydrogenated copolymer has a content of 15 to 45 parts by mass, the natural rubber has a content of 50 to 75 parts by mass, and the butadiene rubber has a content of 5 to 35 parts by mass.

9. A pneumatic tire formed by using the rubber composition according to claim 1 for a base tread.
